(19) United States
(12) Patent Application Publication
(10) Pub. No.: US 2005/0276267 A1
(43) Pub. Date: Dec. 15, 2005

(54) Transmission control method, network element, base station and radio network controller

(76) Inventors: Esa Metsala, Espoo (FI); Tamas Major, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/914,507

(22) Filed: Aug. 10, 2004

(30) Foreign Application Priority Data
Jun. 9, 2004 (FI) 20045213

(51) Int. Cl. H04L 12/56

(52) U.S. Cl. 370/395.2

(57) ABSTRACT

A network element of a communication system comprises, for instance, means (316, 410) for reserving, for connections carrying information packets with non real-time traffic, a predetermined amount less of capacity than the estimated peak rate; means (316, 410) for assorting the information packets with non real-time traffic and information packets with real-time traffic to separate queues, means (316, 410) for removing information packets with non real-time traffic from said non real-time traffic queue.

### FIELD

The invention relates to a transmission control method, a network element, a base station and a radio network controller.

### BACKGROUND

In several communication systems, core network transportation is based on ATM (asynchronous transfer mode). ATM is a transmission procedure based on asynchronous time division multiplexing typically using fixed-length data packets. ATM is usually used for high-speed transportation and switching of various types of data, voice and video signals.

The interface between a controlling unit of a radio communication system and a base station, called lub in WCDMA (wideband code division multiple access), is often a capacity bottleneck of the radio communication system due to transmission capacity consumption and related costs. Even though ATM as a technology provides means for statistical multiplexing, the statistical multiplexing cannot be fully utilized due to the real-time behaviour of the interface and due to a protocol operating over it.

In high capacity packet switched data transmission connections (e.g. for web browsing) it is possible that only few users can reserve the whole capacity of the system, which leads to the reduced end user throughput in the system.

### BRIEF DESCRIPTION OF THE INVENTION

According to an aspect of the invention, there is provided a transmission control method in a communication system, the method comprising: estimating a peak rate of at least one connection carrying information packets with non real-time traffic; reserving, for connections carrying information packets with non real-time traffic, a predetermined amount less of capacity than the estimated peak rate; assorting the information packets with non real-time traffic and information packets with real-time traffic to separate queues, a non real-time traffic queue having a maximum limit for the degree of filling; if the non real-time traffic queue has reached the maximum limit of the degree of filling, removing information packets with non real-time traffic from said non real-time traffic queue.

According to another aspect of the invention, there is provided a network element, comprising: means for estimating a peak rate of at least one connection carrying information packets with non real-time traffic; means for reserving, for connections carrying information packets with non real-time traffic, a predetermined amount less of capacity than the estimated peak rate; means for assorting the information packets with non real-time traffic and information packets with real-time traffic to separate queues, a non real-time traffic queue having a maximum limit for the degree of filling; means for examining whether the non real-time traffic queue has reached the maximum limit of the degree of filling; means for removing information packets with non real-time traffic from said non real-time traffic queue.

According to another aspect of the invention, there is provided a base station, comprising: means for estimating a peak rate of at least one connection carrying information packets with non real-time traffic; means for reserving, for connections carrying information packets with non real-time traffic, a predetermined amount less of capacity than the estimated peak rate; means for assorting the information packets with non real-time traffic and information packets with real-time traffic to separate queues, a non real-time traffic queue having a maximum limit for the degree of filling; means for examining whether the non real-time traffic queue has reached the maximum limit of the degree of filling; means for removing information packets with non real-time traffic from said non real-time traffic queue.

According to another aspect of the invention, there is provided a radio network controller, comprising: means for estimating a peak rate of at least one connection carrying information packets with non real-time traffic; means for reserving, for connections carrying information packets with non real-time traffic, a predetermined amount less of capacity than the estimated peak rate; means for assorting the information packets with non real-time traffic and information packets with real-time traffic to separate queues, a non real-time traffic queue having a maximum limit for the degree of filling; means for examining whether the non real-time traffic queue has reached the maximum limit of the degree of filling; means for removing information packets with non real-time traffic from said non real-time traffic queue.

According to another aspect of the invention, there is provided a base station, being configured to: estimate a peak rate of at least one connection carrying information packets with non real-time traffic; reserve, for connections carrying information packets with non real-time traffic, a predetermined amount less of capacity than the estimated peak rate; traffic a predetermined amount less than the estimated peak rate; assort the information packets with non real-time traffic and information packets with real-time traffic to separate queues, a non real-time traffic queue having a maximum limit for the degree of filling; examine whether the non real-time traffic queue has reached the maximum limit of the degree of filling; remove information packets with non real-time traffic from said non real-time traffic queue.

According to another aspect of the invention, there is provided a radio network controller, being configured to: estimate a peak rate of at least one connection carrying information packets with non real-time traffic; reserve, for connections carrying information packets with non real-time traffic, a predetermined amount less of capacity than the estimated peak rate; assort the information packets with non real-time traffic and information packets with real-time traffic to separate queues, a non real-time traffic queue having a maximum limit for the degree of filling; examine whether the non real-time traffic queue has reached the maximum limit of the degree of filling; remove information packets with non real-time traffic from said non real-time traffic queue.

According to another aspect of the invention, there is provided a network element, being configured to: estimate a peak rate of at least one connection carrying information packets with non real-time traffic; reserve, for connections carrying information packets with non real-time traffic, a predetermined amount less of capacity than the estimated peak rate; assort the information packets with non real-time traffic and information packets with real-time traffic to separate queues, a non real-time traffic queue having a maximum limit for the degree of filling; examine if the non real-time traffic queue has reached the maximum limit of the degree of filling; remove information packets with non real-time traffic from said non real-time traffic queue.

The invention provides several advantages. An embodiment of the invention provides a possibility for controlled overbooking of non real-time users, which makes high capacity data services easier to adopt: even in the case of dense traffic, the system maintains stability and recovers more rapidly after an overload, thus enabling a higher user throughput in a communication system.

### LIST OF DRAWINGS

In the following, the invention will be described in greater detail with reference to the embodiments and the accompanying drawings, in which

FIG. 1 shows an example of a communication system,

FIG. 2 is a flow chart,

FIG. 3 illustrates an example of a base station (node B), and

FIG. 4 illustrates an example of a radio network controller.

### DESCRIPTION OF EMBODIMENTS

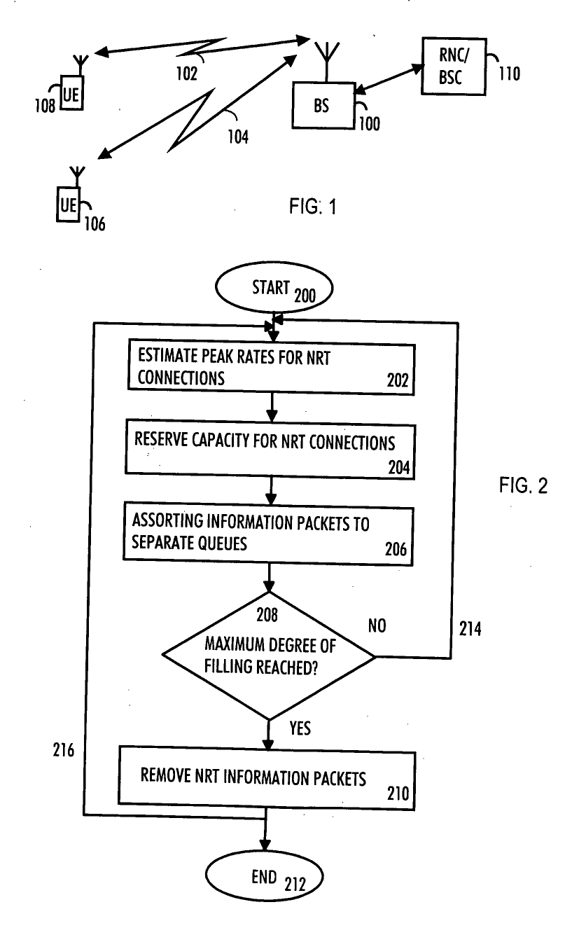

With reference to FIG. 1, we examine an example of a communication system to which embodiments of the invention can be applied. The present invention can be applied to various wireless communication systems. One example of such a communication system is a UMTS (Universal Mobile Telecommunications System) radio access network. It is a radio access network, which includes WCDMA (wideband code division multiple access) technology and can also offer real-time circuit and packet switched services. The embodiments are not, however, restricted to the systems given as examples but a person skilled in the art may apply the solution to other radio systems provided with the necessary properties.

It is clear to a person skilled in the art that the method according to the invention can be applied to systems utilizing different modulation methods or air interface standards.

FIG. 1 is a simplified illustration of a digital data transmission system to which the solution according to the invention is applicable. This is a part of a cellular radio system, which comprises a base station (or node B) 100, which has bi-directional radio links 102 and 104 to subscriber terminals 106 and 108. The subscriber terminals may be fixed, vehicle-mounted or portable. The base station includes transceivers, for instance. From the transceivers of the base station there is a connection to an antenna unit, which establishes the bi-directional radio links to a subscriber terminal. The base station is further connected to a controller 110, a radio network controller (RNC), which transmits the connections of the terminals to the other parts of the network. The radio network controller is further connected to a core network 110 (CN). Depending on the system, the counterpart on the CN side can be a mobile services switching centre (MSC), a media gateway (MGW) or a serving GPRS (general packet radio service) support node (SGSN).

The cellular radio system can also communicate with other networks such as a public switched telephone network or the Internet.

Next, an embodiment of a transmission control method is described by means of FIG. 2. The embodiment allows an interface between a controlling unit of a radio communication system and a base station to be overbooked, because a control mechanism for handling overload situations is available. In principle, overbooking refers to a method for utilizing transport capacity more efficiently by reserving less capacity for non real-time traffic than what is required by a radio access carrier for achieving the peak data rate.

The embodiment is based on routing connections into different virtual channels which have different service qualities according to the service requirements of the connections: real-time (rt) traffic and non real-time traffic (nrt) are divided into separate virtual channels. A typical example of non-real time traffic is packet switched (PS) data connections.

The embodiment is especially suitable for ATM transmissions. ATM (asynchronous transmission mode) is mainly used for high-speed transport and switching of various types of data, voice and video signals. The core network transport in UMTS (universal mobile telecommunications system) is based on ATM.

Usually in UMTS, above the ATM layer is an ATM adaptation layer (AAL). It is used for processing data from higher layers for ATM transmission. Typically, there are five different adaptation layers 0, 1, 2, ¾ and 5. Adaptation layer type 0 means that no adaptation is needed. The other adaptation layers have different properties based on three parameters: real-time requirements, if the bit rate is constant or variable and if data transfer is connection-oriented or connectionless. The embodiment is mainly used in AAL2, which is an ATM adaptation layer that supports variable bit rate (VBR), connection-oriented and time-dependent data traffic.

The embodiment starts in block 200. In block 202, a peak rate of at least one connection carrying information packets with non real-time traffic is estimated. An information packet can also be called a data packet or a packet, for instance. The information packets may be AAL2 CPS packets, CPS meaning a common part sub-layer. Typically, a peak data rate for each AAL2 connection carrying information packets with non-real time traffic is calculated according to the capacities reserved for an air interface. The estimation can be based on several methods, for instance on experience or simulations. For instance, high capacity packet switched data services, such as a 384 kbit/s service, require approximately 500 kbit/s from the lub interface.

In block 204, for connections carrying information packets with non real-time traffic, a predetermined amount less of capacity than the estimated peak rate is reserved.

The information packets may be for instance AAL2 information packets. How much less of capacity than the peak rate is reserved can be determined by taking into account several parameters: the current or expected load of the system, the importance of the traffic transported in the connection, etc. It is also possible that for the selected information packets, capacity is reserved according to the required peak rate.

If less of capacity than the peak rate is reserved for information packets, more AAL2 connections with user traffic can be admitted within an ATM VCC (asynchronous traffic mode virtual channel connection); this is called overbooking in this application. VCC is a concatenation of virtual channel links that forms an ATM connection between a transmitting party and a receiving party.

In block 206, the information packets with non real-time traffic and information packets with real-time traffic are assorted to separate queues, a non real-time traffic queue having a maximum limit for the degree of filling.

Typically, AAL2 connections with non real-time traffic and with real-time traffic are assorted to separate AAL2 paths (meaning ATM VCCs). Consequently the traffic (ML2 CPS packets, CPS meaning common part sub-layer) within those connections is also assorted to separate queues.

The maximum limit for the degree of filling (for example the number of AAL2 CPS packets) is selected in such a way that it is suitable for the current needs.

If the non real-time traffic queue has reached the maximum limit of the degree of filling, information packets with non real-time traffic are removed from said non real-time traffic queue, blocks 208 and 210.

Usually in the prior art, new packets are put into the AAL2 queue until it is full, which results in an overload situation. Since higher layer packets (FP, frame protocol) do not get through, the user terminal asks RLC (radio link control) for retransmissions. Retransmissions are scheduled, which increases congestion: more and more traffic tries to enter the already full AAL2 layer queue.

In UMTS, frame protocol (FP) is typically used for transporting user data frames between the serving radio network controller (SRNC) and the base station (BS) over the lub and lur interfaces.

Using the overload control mechanism of the embodiment, information packets are removed from the queue. The queue can be completely emptied or only selected information packets are removed from the queue. The removal may be based on different kinds of principles: packets from less important connections are removed first, packets are removed until congestion is over, a predetermined number of packets of the queue is removed, the packets of the connection which caused the congestion are removed, etc. After emptying the queue or removing the selected information packets from it, capacity is available and the end user throughput is thus improved. In practise, the level of throughput usually also depends on the dimensioning of the non real-time user VCC (virtual channel connection).

The embodiment ends in block 212.

Arrow 214 depicts that if the non real-time traffic queue is not full, new information packets may be put into the queue if there are new connections available. Arrow 216 depicts one possibility for repeating the embodiment: if there are new connections available, the method is repeated.

Next some examples of network elements to which the embodiments of the invention are applicable are explained.

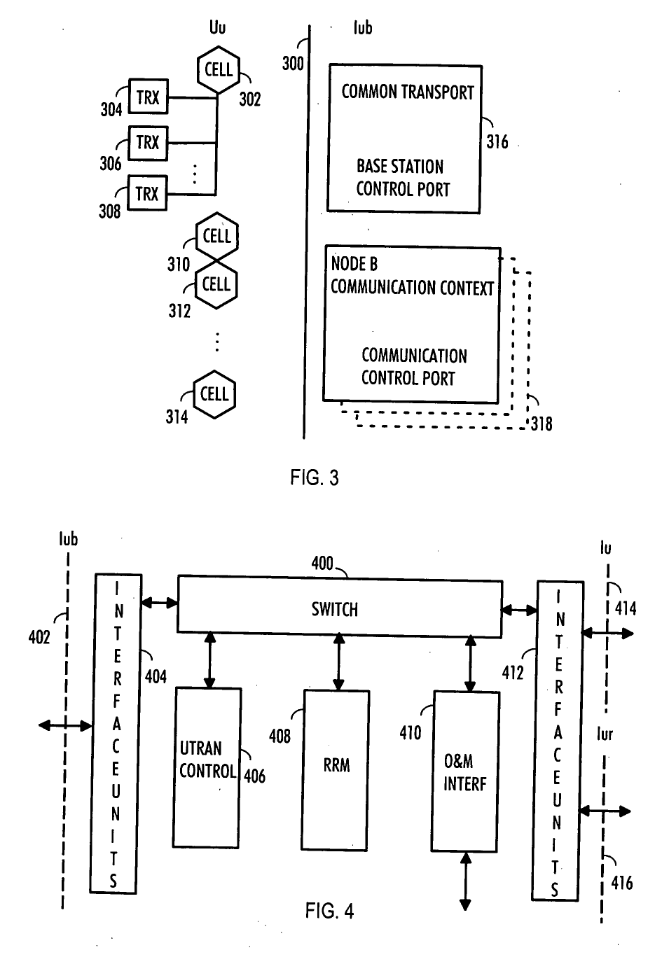

FIG. 3 shows an example of a base station's (or node B's) logical structure. A base station is herein taken as an example of a network element. On the lub interface 300 side, the base station includes two entities: a common transport entity 316 and a plurality of traffic termination points (TTP) 318. The common transport entity represents the transport channels that are common for all user terminals in the cell and the transport channels used for initial access. The common transport entity also includes different data ports, such as a random access channel (RACH) port, a forward access channel (FACH) port and a common packet channel (CPCH) port.

RACH is an uplink channel that is used for carrying control information from user terminals and that may also carry short user packets, and FACH is a downlink transport channel used by user terminals for receiving information.

The common transport entity also includes a base station (Node B) control port used for operation and maintenance (O&M) purposes. One traffic termination point 318 includes a plurality of base station communication contexts. A communication context comprises information about activities in a traffic termination point related to a user terminal. The communication context can be used for associating a set of radio links together at the base station. A base station communication context may, for example, include one or more dedicated channels (DCH). A downlink shared channel also belongs to a base station communication context.

The common transport entity also includes a communication control port.

From the point of view of UMTS network infrastructures, the base station may be thought to be a logical O&M entity that is a subject to network management functions.

On the Uu (user interface) side, the base station includes a plurality of logical entities typically called cells 302, 310, 312, 314. A cell has one or more transceivers (TRX) 304, 306, 308 below it. The transceivers carry out various functions concerning data transmission and reception.

The precise implementation of the base station is vendor-dependent.

The disclosed functionalities of the embodiments of the invention, such as the peak rate estimation or the removal of information packets, can be advantageously implemented by means of software in the common transport functions 316 of the base station. Other implementation solutions are also possible, such as different hardware implementations, e.g. a circuit built of separate logics components or one or more client-specific integrated circuits (Application-Specific Integrated Circuit, ASIC). A hybrid of these implementations is also feasible.

Referring to FIG. 4, a simplified block diagram illustrates an example of a radio network controller's (RNC) logical structure. RNC is herein taken as another example of a network element.

RNC is the switching and controlling element of UTRAN. The switching 400 takes care of connections between the core network and the user terminal. The radio network controller is located between lub 402 and lu 414 interfaces. The network controller in connected to these interfaces via interface units 404, 412. There is also an interface for inter-RNC transmission, called lur 416. The functionality of the radio network controller can be classified into two classes: UTRAN radio resource management 408 and control functions 406. An operation and management interface function 410 serves as a medium for information transfer to and from network management functions. The radio resource management is a group of algorithms for sharing and managing the radio path connection so that the quality and capacity of the connection are adequate. The most important radio resource management algorithms are handover control, power control, admission control, packet scheduling, and code management. The UTRAN control functions take care of functions related to the set-up, maintenance and release of a radio connection between the base stations and user terminals. Therefore, the hard handover methods described above are mainly carried out in the radio resource block 408 and UTRAN control block 406. The radio resource block 408 and control functions block 406 can be combined for performing a radio resource control (RRC) unit of a serving radio network controller (SRNC-RRC).

The precise implementation of the radio network controller (RNC) is vendor-dependent.

The disclosed functionalities of the embodiments of the invention, such as the peak rate estimation or the removal of information packets, can be advantageously implemented by means of software in the operation and management interface functions 410 of a radio network controller. Other implementation solutions are also possible, such as different hardware implementations, e.g. a circuit built of separate logics components or one or more client-specific integrated circuits (Application-Specific Integrated Circuit, ASIC). A hybrid of these implementations is also feasible.

The embodiments may also be implemented in MSC (mobile services switching centre). Some other abbreviations sometimes used to refer to a switching centre of a communication system include: MTX, USC and MX. The switching centre is a network element which performs the required switching functions and controls the co-operation with other networks.

Even though the invention has been described above with reference to an example according to the accompanying drawings, it is clear that the invention is not restricted thereto but it can be modified in several ways within the scope of the appended claims.

1. A transmission control method in a communication system, the method comprising:
estimating a peak rate of at least one connection carrying information packets with non real-time traffic;
reserving, for connections carrying said information packets with non real-time traffic, a predetermined amount less of capacity than an estimated peak rate;
assorting the information packets with non real-time traffic and information packets with real-time traffic to separate queues, a non real-time traffic queue having a maximum limit for a degree of filling; and
removing the information packets with non real-time traffic from said non real-time traffic queue if the non real-time traffic queue has reached the maximum limit for the degree of filling.

2. The method of claim 1, further comprising:
emptying the non real-time traffic queue when the information packets with non real-time traffic are removed from the non real-time traffic queue.

3. The method of claim 1, further comprising:
using asynchronous transmission mode (ATM) in the communication system and, wherein the method is applied on AAL2, which comprises an ATM adaptation layer.

4. The method of claim 1, wherein the reserving step comprises taking at least one of the following parameters into account: current or expected load of the system and importance of the traffic transported in the connection.

5. The method of claim 1, wherein the removing step is based on at least one of a set of principles including: packets from less important connections are removed first, particular packets are removed until congestion is over, a predetermined number of packets of the queue is removed, and packets of a connection which caused the congestion are removed.

6. A network element, comprising:
estimating means for estimating a peak rate of at least one connection carrying information packets with non real-time traffic;
first reserving means for reserving, for connections carrying the information packets with the non real-time traffic, a predetermined amount less of capacity than an estimated peak rate;
assorting means for assorting the information packets with the non real-time traffic and information packets with real-time traffic to separate queues, a non real-time traffic queue having a maximum limit for a degree of filling;
examining means for examining whether the non real-time traffic queue has reached the maximum limit of the degree of filling; and
first removing means for removing information packets with non real-time traffic from said non real-time traffic queue.

7. The network element of claim 6, further comprising:
emptying means for emptying the non real-time traffic queue.

8. The network element of claim 6, the network element being a part of a communication system which uses asynchronous transmission mode (ATM).

9. The network element of claim 6, further comprising:
second reserving means for reserving capacity for the connections carrying the information packets with non real-time traffic, taking into account at least one of a set of parameters including: current or expected load of a system and importance of traffic transported in the connection.

10. The network element of claim 6, further comprising:
second removing means for removing the information packets based on at least one of a set of principles including: packets from less important connections are removed first, particular packets are removed until congestion is over, a predetermined number of packets of the queue are removed, and packets of a connection which caused the congestion are removed.

11. A base station, comprising:
estimating means for estimating a peak rate of at least one connection carrying information packets with non real-time traffic;
reserving means for reserving, for connections carrying the information packets with non real-time traffic, a predetermined amount less of capacity than an estimated peak rate;
assorting means for assorting the information packets with non real-time traffic and information packets with real-time traffic to separate queues, a non real-time traffic queue having a maximum limit for a degree of filling;
examining means for examining whether the non real-time traffic queue has reached a maximum limit of the degree of filling; and
removing means for removing the information packets with non real-time traffic from said non real-time traffic queue.

12. A radio network controller, comprising:
estimating means for estimating a peak rate of at least one connection carrying information packets with non real-time traffic;
reserving means for reserving, for connections carrying the information packets with non real-time traffic, a predetermined amount less of capacity than an estimated peak rate;
assorting means for assorting the information packets with non real-time traffic and information packets with real-time traffic to separate queues, a non real-time traffic queue having a maximum limit for a degree of filling;
examining means for examining whether the non real-time traffic queue has reached a maximum limit of the degree of filling; and
removing means for removing the information packets with non real-time traffic from said non real-time traffic queue.

13. A base station, being configured to:
estimate a peak rate of at least one connection carrying information packets with non real-time traffic;
reserve, for connections carrying the information packets with non real-time traffic, a predetermined amount less of capacity than an estimated peak rate;
traffic a predetermined amount less than an estimated peak rate;
assort the information packets with non real-time traffic and information packets with real-time traffic to separate queues, a non real-time traffic queue having a maximum limit for a degree of filling;
examine whether the non real-time traffic queue has reached a maximum limit of the degree of filling; and
remove the information packets with non real-time traffic from said non real-time traffic queue.

14. A radio network controller, being configured to:
estimate a peak rate of at least one connection carrying information packets with non real-time traffic;
reserve, for connections carrying the information packets with non real-time traffic, a predetermined amount less of capacity than an estimated peak rate;
assort the information packets with non real-time traffic and information packets with real-time traffic to separate queues, a non real-time traffic queue having a maximum limit for a degree of filling;
examine whether the non real-time traffic queue has reached a maximum limit of the degree of filling; and
remove the information packets with non real-time traffic from said non real-time traffic queue.

15. A network element, being configured to:
estimate a peak rate of at least one connection carrying information packets with non real-time traffic;
reserve, for connections carrying the information packets with non real-time traffic, a predetermined amount less of capacity than an estimated peak rate;
assort the information packets with non real-time traffic and information packets with real-time traffic to separate queues, a non real-time traffic queue having a maximum limit for a degree of filling;
examine if the non real-time traffic queue has reached a maximum limit of the degree of filling; and
remove the information packets with non real-time traffic from said non real-time traffic queue.

16. A network element, comprising:
first processor configured to estimate a peak rate of at least one connection carrying information packets with non real-time traffic;
a second processor configured to reserve, for connections carrying the information packets with the non real-time traffic, a predetermined amount less of capacity than an estimated peak rate;
a third processor configured to assort the information packets with the non real-time traffic and information packets with real-time traffic to separate queues, a non real-time traffic queue having a maximum limit for a degree of filling;
a fourth processor configured to examine whether the non real-time traffic queue has reached the maximum limit of the degree of filling; and
a fifth processor configured to remove information packets with non real-time traffic from said non real-time traffic queue.

17. A base station, comprising:
a first processor configured to estimate a peak rate of at least one connection carrying information packets with non real-time traffic;
a second processor configured to reserve, for connections carrying the information packets with non real-time traffic, a predetermined amount less of capacity than an estimated peak rate;
a third processor configured to assort the information packets with non real-time traffic and information packets with real-time traffic to separate queues, a non real-time traffic queue having a maximum limit for a degree of filling;
a fourth processor configured to examine whether the non real-time traffic queue has reached a maximum limit of the degree of filling; and
a fifth processor configured to remove the information packets with non real-time traffic from said non real-time traffic queue.
